(19) United States
(12) Patent Application Publication
(10) Pub. No.: US 2006/0269816 A1
(43) Pub. Date: Nov. 30, 2006

(54) Proton conducting inorganic material, polymer nano-composite membrane including the same, and fuel cell adopting the polymer nano-composite membrane

(75) Inventors: Hae-kyoung Kim, Seoul (KR); Jae-sung Lee, Pohang-si (KR); Hyuk Chang, Seongnam-si (KR); Young-kwon Kim, Pohang-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/438,268

(22) Filed: May 23, 2006

(30) Foreign Application Priority Data
May 25, 2005 (KR) 2005-44254

(51) Int. Cl. H01M 8/10

(52) U.S. Cl. 429/33; 429/314

(57) ABSTRACT

A proton conducting inorganic material having a layered structure in which a sulfonic acid group-containing moiety having proton conductivity is introduced in between the layers of an inorganic material having a nano-sized interlayer distance such that the sulfonic acid group-containing moiety is directly bound to the inorganic material via an ether bond. A polymer nano-composite membrane including the product of a reaction between the inorganic material having the sulfonic acid-containing moiety with a proton conducting polymer, and a fuel cell adopting the same, wherein the polymer nano-composite membrane has a structure in which a proton conducting polymer is intercalated between the layers of the proton conducting inorganic material having a layered structure, or a structure in which the product of exfoliating the proton conducting inorganic material having a layered structure is dispersed in a proton conducting polymer. The polymer nano-composite membrane can have a controllable degree of swelling in a methanol solution, and the transmittance of the polymer nano-composite membrane can be reduced

### CROSS-REFERENCE TO RELATED APPLICATION

This application claims the benefit of Korean Patent Application No. 2005-44254, filed on May 25, 2005 in the Korean Intellectual Property Office, the disclosure of which is incorporated herein by reference.

### BACKGROUND OF THE INVENTION

1. Field of the Invention

An aspect of he present invention relates to a proton conducting inorganic material, a polymer nano-composite membrane including the same, and a fuel cell adopting the same, and more particularly, to a polymer nano-composite membrane having reduced permeability to water and methanol and improved thermal stability, and a fuel cell having improved energy density and fuel efficiency by adopting the polymer nano-composite membrane.

2. Description of the Related Art

A direct methanol fuel cell (DMFC) utilizing liquid methanol as a fuel is considered to be a clean energy source of the future that can replace fossil energy sources. Since DMFCs are operable at room temperature and can be produced with a small size with perfect sealing, they can be used in a wide range of applications such as pollution-free automobiles, domestic power generating systems, mobile communication systems, medical instruments, armaments, space facilities and portable electronic devices.

A DMFC produces direct current electricity through an electrochemical reaction between methanol and oxygen. The fundamental structure of a conventional DMFC is illustrated in FIG. 1A.

Referring to FIG. 1A, a proton conducting membrane 11 is interposed between an anode and a cathode, and the fuel for the electrochemical reaction is supplied to the proton conducting membrane 11.

The proton conducting membrane 11 is mainly composed of a solid polymer electrolyte and has a thickness of 50 to 200 μm. The anode and the cathode are disposed such that catalyst layers 12 and 13 are respectively located adjacent to a cathode support layer 14 and an anode support layer 15. The cathode support layer 14 and the anode support layer 15 are made of carbon fabric or carbon paper, and are surface-treated so that a gas or liquid to undergo a reaction can be easily supplied to the cathode support layer 14 and the anode support layer 15 and the water to be transported to the proton conducting membrane 11 and the water produced in the reaction can easily pass through the cathode support layer 14 and the anode support layer 15. A bipolar plate 16 has grooves for gas injection, and also functions as a current collector.

In the DMFC illustrated in FIG. 1A, when the fuel for the reaction is supplied, an oxidation reaction occurs at the anode, and methanol and water are converted into carbon dioxide, protons and electrons. The produced protons are transferred to the cathode via the proton conducting membrane.

On the other hand, a reduction reaction occurs at the cathode, and oxygen molecules in air receive electrons to produce oxygen ions, which in turn react with the protons transported from the anode to generate water molecules.

The proton conducting membrane is a solid polymer membrane and performs the role of separating the fuel supplied to the anode and the cathode and conveying the protons generated at the anode to the cathode.

The solid polymer membrane is usually made of NAFION, which is available from DuPont Corp. The backbone of the polymer forming the solid polymer membrane is hydrophobic while the side chains of the polymer contain hydrophilic groups; thus, the solid polymer membrane can hold water, and transport protons through the clusters formed by the water held by the solid polymer membrane. Therefore, the solid polymer membrane for a fuel cell can be composed of a polymer containing a greater amount of water and thus having enhanced proton conductivity for the effective conveyance of protons.

The DMFC makes use of an aqueous solution of methanol as a fuel, and swelling of the solid polymer membrane may occur according to the methanol concentration in the aqueous methanol solution. When using an aqueous methanol solution as a fuel, the swelling of the polymer membrane causes the fuel that has not been oxidized in the electrochemical reaction to permeate from the anode to the cathode through the solid polymer membrane, and thus wastes fuel as well as deteriorates the cell performance due to the mixed potential at the cathode.

In order to solve the problems mentioned above, it is essential to develop a solid polymer membrane for the DMFC.

Methods have been suggested to reduce the permeability of the aqueous methanol solution by using heat-resistant polymers or rigid polymers in the formation of solid polymer membranes for DMFCs (U.S. Pat. No. 5,795,496, U.S. Pat. No. 6,194,474, and U.S. Pat. No. 6,510,047). According to these methods, permeation of methanol can be markedly reduced, but the ion conductivities of the polymer membranes are also significantly decreased. Thus, when the polymer membranes with reduced ion conductivities are used, the cell performance such as output density or the like is largely deteriorated.

Other methods, in which inorganic nanoparticles are dispersed in the solid polymer membranes, have also been suggested (U.S. Pat. No. 6,017,632 and U.S. Pat. No. 6,057,035). However, these methods are adversely affected by the aggregation of the inorganic nanoparticles, and even though simple mixing of inorganic nanoparticles and the polymer of the solid polymer membrane markedly reduces the permeation of methanol, the ion conductivities of the polymer membranes also decrease.

### SUMMARY OF THE INVENTION

In order to solve the above and/or other problems described above, an aspect of the present invention provides a solid polymer membrane with lower methanol permeability and equal or greater ion conductivity than conventional NAFION membranes, a material for forming the same, and a method of producing the same.

Another aspect of the present invention provides a fuel cell adopting the solid polymer membrane, and thus having improved fuel efficiency.

According to an aspect of the present invention, there is provided a proton conducting inorganic material having a layered structure including an inorganic material having a nano-sized interlayer distance and a sulfonic acid group-containing moiety having proton conductivity introduced between the layers of the inorganic material having a nano-sized interlayer distance such that the sulfonic acid group-containing moiety is directly bound to the inorganic material via an ether bond.

The sulfonic acid-containing moiety directly bound to the inorganic material having a nano-sized interlayer distance via an ether bond is:
—O-AR₁SO₃H i)

wherein R₁ is a substituted or unsubstituted C1-C12 alkylene group or a substituted or unsubstituted C1-C12 alkenylene group, A is —C═O— or —C(R′)(R″)—, and R′ and R″ are each independently hydrogen or C1-C10 alkyl, or R′ and R″ together form a ring represented by the following formula:

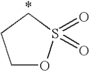

wherein * indicates the position where R′ and R″ are attached to carbon; or
—O—C(R₂)(X)C(Y₁)(Y₂)SO₃H ii)

wherein R₂ is —F, —Cl, —SF₅, ═SF₄, —SF₄Cl, —CF₃, —CF₂CF₃, —H(CF₂)₄, a C1-C12 alkyl group, a C1-C12 halogenated alkyl group, a C1-C12 alkenyl group, a C1-C12 halogenated alkenyl group, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula:

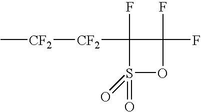

wherein X is —F, —H, —Cl or —CF₃, and Y₁ and Y₂ are each independently F or Cl.

The sulfonic acid group-containing moiety directly bound to the inorganic material having a nano-sized interlayer distance via an ether bond may be —O(CH₂)ₙSO₃H wherein n is an integer from 1 to 13, or —O—C(R₂)(X)CF₂SO₃H wherein R₂ is —F, —CF₃, —SF₅, ═SF₄, —SF₄Cl, —CF₂CF₃ or —H(CF₂)₄, and X is —F, —H, —Cl or —CF₃.

According to another aspect of the present invention, there is provided a method of producing a proton conducting inorganic material having a layered structure, the method including sulfonating an inorganic material having a nano-sized interlayer distance by adding a sultone compound to the surface of the inorganic material having a nano-sized interlayer distance.

The surface of the inorganic material having a nano-sized interlayer distance may be subjected to a surface hydrophilic pretreatment, before the reaction with the sultone compound.

Further, before the surface hydrophilic treatment of the inorganic material having a nano-sized interlayer distance, surfactants may be added to the inorganic material.

According to another aspect of the present invention, there is provided a polymer nano-composite membrane including a proton conducting polymer; and a proton conducting inorganic material having a layered structure including an inorganic material having a nano-sized interlayer distance, and a sulfonic acid group-containing moiety having proton conductivity introduced between the layers of the inorganic material having a nano-sized interlayer distance such that the sulfonic acid group-containing moiety is directly bound to the inorganic material having a nano-sized interlayer distance via an ether (—O—) bond.

The polymer nano-composite membrane has a structure in which the proton conducting polymer is intercalated between the layers of the proton conducting inorganic material having a layered structure. The polymer nano-composite membrane may also have a structure in which a product obtained by exfoliating the respective layers constituting the proton conducting inorganic material having a layered structure is dispersed in the proton conducting polymer, or the polymer nano-composite membrane may have a combined structure of the proton conducting polymer intercalated between the layers of the proton conducting inorganic material having a layered structure and a product obtained by exfoliating the respective layers constituting the proton conducting inorganic material having a layered structure dispersed in the proton conducting polymer.

According to another aspect of the present invention, there is provided a method of producing a polymer nano-composite membrane including reacting the proton conducting inorganic material having a layered structure with the proton conducting polymer at 20 to 90° C., and then subjecting the reaction product to a film forming process.

The film forming process is carried out by placing the reaction product of the proton conducting inorganic material and the proton conducting polymer in a mold for a polymer membrane and maintaining the mold in an oven kept at 40 to 150° C.

According to another respect of the present invention, there is provided a fuel cell including a polymer nano-composite membrane including the reaction product between the proton conducting inorganic material having a layered structure and the proton conducting polymer.

According to another embodiment of the present invention, the fuel cell is a direct methanol fuel cell.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a diagram illustrating the structure of a direct methanol fuel cell;

FIG. 1B is a schematic diagram illustrating the production process for a proton conducting inorganic material having a layered structure according to an embodiment of the present invention;

FIG. 2 is an X-ray photoelectron spectroscopy diagram verifying the presence of an SO₃H functional group in laminate proton conducting inorganic materials of Examples 1 through 3 according to embodiments of the present invention;

FIG. 3 is a thermal gravimetric analysis graph verifying the thermal properties of the sulfonated proton conducting inorganic material produced in Example 3 according to an embodiment of the present invention and of montmorillonite of Comparative Example 1 according to the prior art;

FIG. 4 is a graph showing the permeability properties to water and methanol of polymer nano-composite membranes of Examples 4 through 6 according to embodiments of the present invention and of a polymer membrane of Comparative Example 1 according to the prior art;

FIG. 5 is a graph showing the ion conductivities of the polymer nano-composite membranes of Examples 4 through 6 according to embodiments of the present invention and of the polymer membrane of Comparative Example 1 according to the prior art;

FIG. 6 is a micrograph obtained with a transmission electron microscope (TEM) showing a cross-sectional view of the polymer nano-composite membrane of Example 6 according to an embodiment of the present invention;

FIG. 7 is a graph showing the energy density properties of a fuel cell of Example 7 according to an embodiment of the present invention and a fuel cell of Comparative Example 1 according to the prior art; and

FIG. 8 is a graph showing the MEA performances of the fuel cell of Example 7 according to an embodiment of the present invention and the fuel cell of Comparative Example 1 according to the prior art.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In a proton conducting inorganic material according to an embodiment of the present invention, a sulfonic acid group-containing moiety imparting protonicity is introduced between layers composed of a proton conducting inorganic material having a nano-sized interlayer distance, the sulfonic acid group-containing moiety being directly bound to the proton conducting inorganic material via an ether bond.

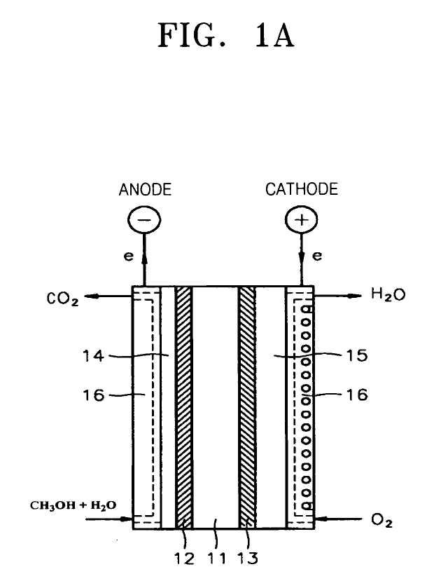

The production process of the proton conducting inorganic material is schematically illustrated in FIG. 1B, which illustrates an embodiment in which montmorillonite clay is used as the proton conducting inorganic material having a nano-sized interlayer distance.

In FIG. 1B, in order to hydrophilically treat montmorillonite, which is an inorganic material having a nano-sized interlayer distance, the montmorillonite is dispersed in an acidic solution to hydrophilically treat the surface of the montmorillonite.

The montmorillonite is treated with an acid solution in order to replace inorganic cations, such as Na⁺, K⁺, Mg⁺ and the like present in between layers of the montmorillonite, with protons (H⁺). The acid solution that can be used for this may be sulfuric acid, hydrochloric acid, nitric acid or the like.

The amount of the acid solution used in the treatment may be 1000 to 2000 parts by weight based on 100 parts by weight of the montmorillonite, and the treatment of the montmorillonite may be carried out at 90 to 100° C. for 6 to 24 hours.

Subsequently, the reaction product is reacted with a sultone compound, which is then directly bound to a surface of the montmorillonite via an ether bond. Here, it is also possible to treat the montmorillonite with a surfactant such as dodecylamine before the hydrophilic treatment to increase the interlayer distance of the montomorillonite.

According to some embodiments of the present invention, the inorganic material having a nano-sized interlayer distance may include at least one inorganic material selected from the group consisting of montmorillonite, hydrated sodium calcium aluminium magnesium silicate hydroxide, pyrophyllite, talc, vermiculite, sauconite, saponite, nontronite, amesite, baileychlore, chamosite, clinochlore, kaemmererite, kookeite, corundophilite, daphnite, delessite, gonyerite, nimite, odinite, orthochamosite, penninite, pannantite, rhipidolite, prochlore, sudoite, thuringite, kaolinite, dickite and nacrite.

The inorganic material having a nano-sized interlayer distance has a particle size of several hundred nanometers and has an interlayer distance in the range of 0.1 to 10 nm.

The treatment of the montmorillonite requires a solvent to dissolve or disperse the inorganic material having a nano-sized interlayer distance, and the solvent may be toluene, hexane, DMF or the like. The amount of the solvent may be 1000 to 3000 parts by weight based on 100 parts by weight of the inorganic material having a nano-sized interlayer distance.

It is also possible to perform a pretreatment process for adding surfactants, prior to the hydrophilic treatment of the inorganic material having a nano-sized interlayer distance, in order to maintain an appropriate interlayer distance of the inorganic material and to maintain the treatment of the montmorillonite at a suitable acidity. To this end, any surfactant that is suitable for this purpose can be used, and in particular, non-ionic surfactants such as dodecylamine, cetyltrimethylammonium bromide, dodecyltrimethylammonium bromide, tetrabutylammonium hydroxide and mixtures thereof can be used. The amount of the surfactant may be 0.001 to 0.03 moles based on 1 mole of the inorganic material having a nano-sized interlayer distance.

As described above, after hydrophilically treating the inorganic material having a nano-sized interlayer distance, a sultone compound is added to the inorganic material having a nano-sized interlayer distance to carry out a sulfonation reaction and to thus obtain a proton conducting inorganic material having a layered structure modified with a sulfonic acid group at the terminal.

The sultone compound can be a sultone compound represented by Formula 1 or a fluorinated sultone compound represented by Formula 2:

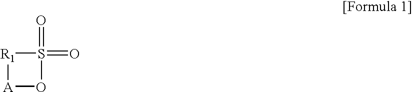

wherein R₁ is a substituted or unsubstituted C1-C12 alkylene group or a substituted or unsubstituted C1-C12 alkenylene group, A is —C═O— or —C(R′R″)—, and R′ and R″ are each independently hydrogen or a C1-C10 alkyl group, or R′ and R″ together form a ring represented by the following formula:

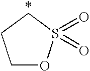

wherein * indicates the position where R′ and R″ are attached to carbon; and

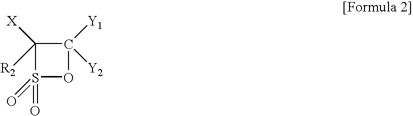

wherein R₂ is —F, —Cl, —SF₅, ═SF₄, —SF₄Cl, —CF₃, —CF₂CF₃, —H(CF₂)₄, a C1-C12 alkyl group, a C1-C12 halogenated alkyl group, a C1-C12 alkenyl group, a C1-C12 halogenated alkenyl group, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula:

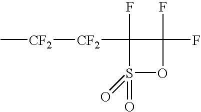

wherein X is —F, —H, —Cl or —CF₃, and Y₁ and Y₂ are each independently F or Cl.

Examples of the sultone compound represented by Formula 1 include 1,3-propanesultone (A), 1,4-butanesultone (B), and compound (C) through compound (S) represented by the following formulas:

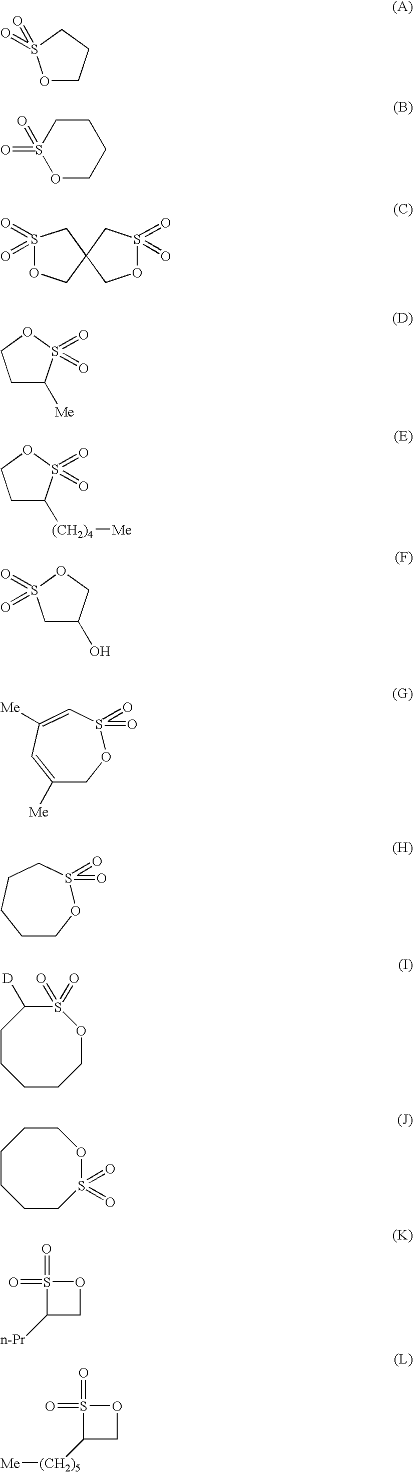

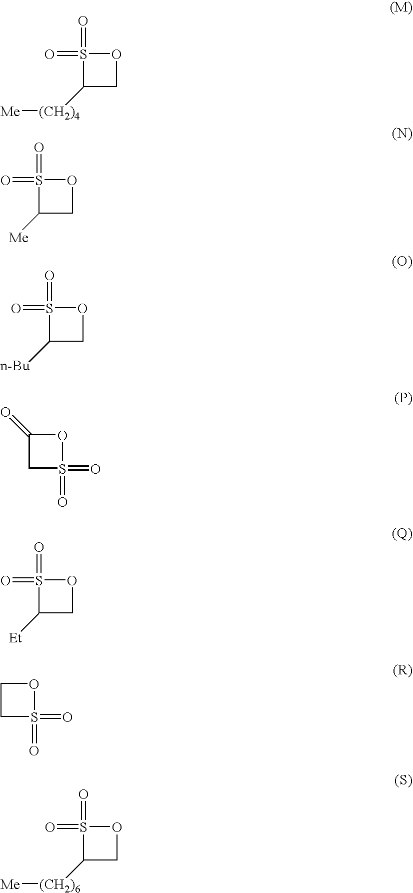

Examples of the fluorinated sultone compound represented by Formula 2 include 1-trifluoromethyl-1,2,2-trifluoroethanesulfonic acid sultone (A′), 1-trifluoromethyl-2,2-bifluoroethanesulfonic acid sultone (B′), 4H-perfluorobutyl-1,2,2-trifluoroethanesulfonic acid sultone (C′), compound (D′) through compound (Z′), and compound (a′) through compound (b′) represented by the following formulas:

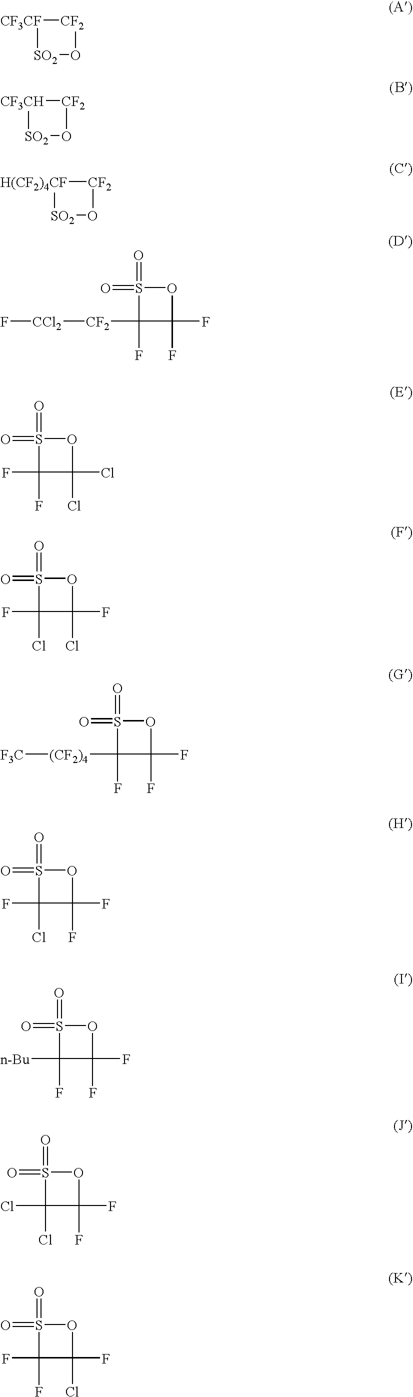

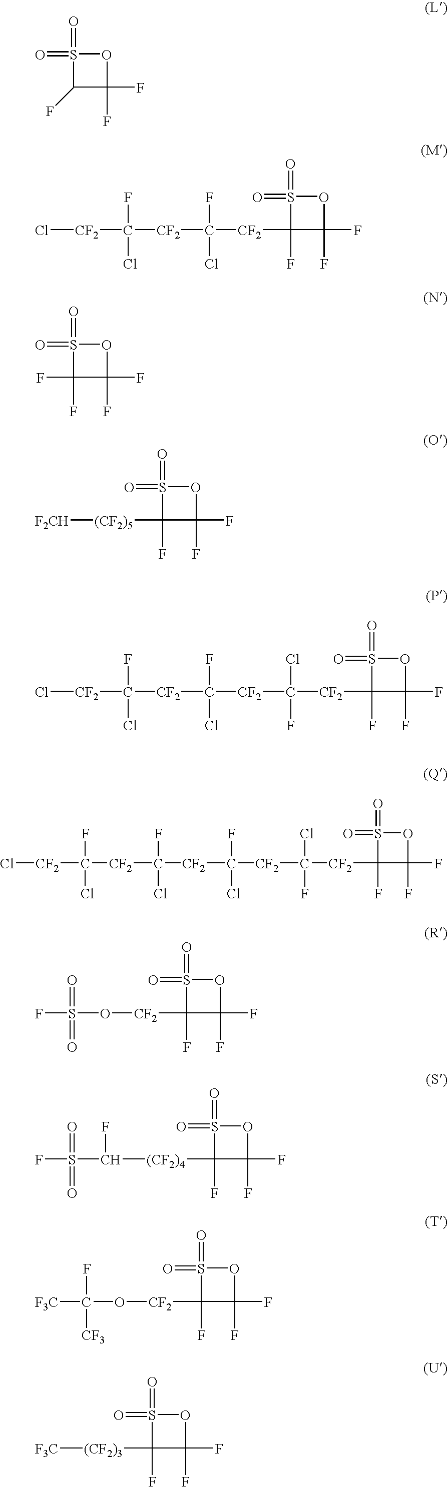

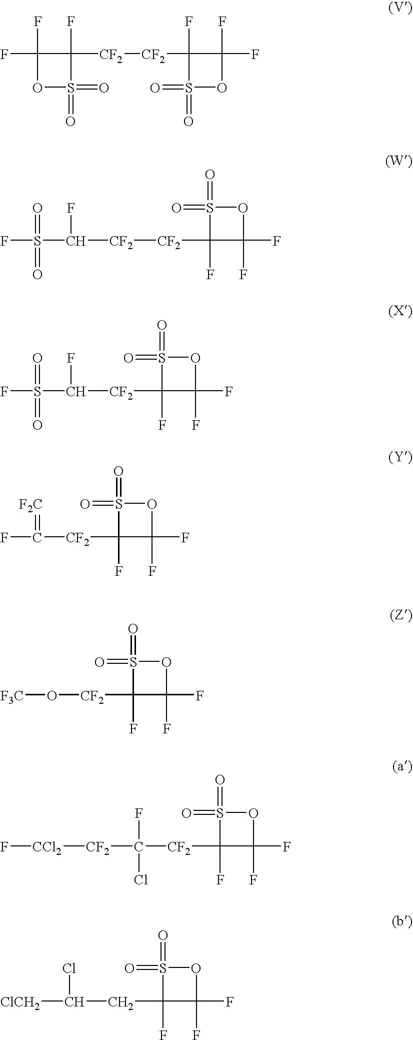

The proton conducting inorganic material having a layered structure according to an embodiment of the present invention has an interlayer distance of 0.1 to 10 nm, and the particle diameter of the proton conducting inorganic material having a layered structure ranges from 10 nm to 100 m.

The ion exchange capacity (IEC) of the inorganic material having a layered structure ranges from 0.01 to 5 mmol/g.

During the sulfonation reaction, 0.1 moles to 2 moles of the sultone compound are used based on 1 mole of the inorganic material having a nano-sized interlayer distance. When the amount of the sultone compound is less than 0.1 moles, the yield of the sulfonation reaction generally decreases. When the amount of the sultone compound exceeds 2 moles, the sultone compound partly remains unreacted and is thus wasted.

The sulfonation reaction is carried out at the boiling temperature of the solvent used (reflux temperature) for about 6 to 24 hours.

As a result of the reaction with the sultone compound, the proton conducting inorganic material having a layered structure contains a sulfonic acid (SO₃H) group-containing moiety which is directly bound to one surface of the proton conducting inorganic material having a layered structure via an ether bond.

In the production process of the proton conducting inorganic material having a layered structure described above, when the sultone compound of Formula 1 is used as the reactant sultone compound, an —O-AR₁SO₃H group is introduced to the surface of the inorganic material having a nano-sized interlayer distance as the sulfonic acid group-containing moiety which is directly bound to the titanate constituting the inorganic material having a nano-sized interlayer distance via an ether bond. In the above formula, R₁ is a substituted or unsubstituted C1-C12 alkylene group, or a substituted or unsubstituted C1-C12 alkenylene group, and A is —C═O— or —C(R′)(R″)— [wherein R′ and R″ are each independently hydrogen or a C1-C10 alkyl group, or R′ and R″ together may form a ring represented by the following formula:

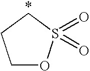

(wherein * indicates the position where R′ and R″ are attached to carbon)].

When the sultone compound of Formula 2 is used as the reactant sultone compound, an —O—C(R₂)(X)C(Y₁)(Y₂)SO₃H group is introduced to the surface of the inorganic material having a nano-sized interlayer distance as the sulfonic acid group-containing moiety which is directly bound to the titanate constituting the inorganic material having a nano-sized interlayer distance via an ether bond. In the above formula, R₂ is —F, —Cl, —SF₅, ═SF₄, —SF₄Cl, —CF₃, —CF₂CF₃, —H(CF₂)₄, C1-C12 alkyl, C1-C12 halogenated alkyl, C1-C12 alkenyl, C1-C12 halogenated alkenyl, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula:

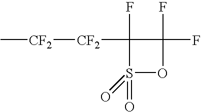

wherein X is —F, —H, —Cl or —CF₃; and Y₁ and Y₂ are each independently F or Cl.

The sulfonic acid group-containing moiety that is directly bound to the inorganic material having a nano-sized interlayer distance via an ether bond may be —O—(CH₂)ᵣSO₃H, wherein n is an integer from 1 to 13, or —O—C(R₂)(X)CF₂SO₃H, wherein R₂ is —F, —CH₃, —SF₅, ═SF₄, —SF₄Cl, —CF₂CF₃ or —H(CF₂)₄, and X is —F, —H, —Cl or —CF₃.

The proton conducting inorganic material having a layered structure obtained through the process described above is subjected to purification and drying before being used in the production of a polymer nano-composite membrane.

The polymer nano-composite membrane according to an embodiment of the present invention is produced through a reaction between the proton conducting inorganic material having a layered structure and a proton conducting polymer. To be more specific, the proton conducting inorganic material having a layered structure and the proton conducting polymer are mixed through vigorous stirring at a temperature of 20 to 150° C. for 12 hours or more, and then are allowed to react. The reaction time may vary depending on the reaction temperature, but the reaction time may be, for example, 3 hours to 24 hours. When the reaction temperature is lower than 20° C., the mixing state of the proton conducting inorganic material having a layered structure and the proton conducting polymer is poor, and when the reaction temperature is higher than 150° C., the proton conducting inorganic material having a layered structure and the proton conducting polymer tend to decompose or deteriorate, which is undesirable.

In the reaction described above, for example, the polymer nano-composite membrane according to an embodiment of the present invention can be produced by mixing the proton conducting inorganic material having a layered structure and the proton conducting polymer at a particular predetermined mixing ratio, and then allowing the inorganic material having a layered structure and the polymer to react in an autoclave at 80° C. and 1 to 5 atmospheres for 12 hours or more. Alternatively, the polymer nano-composite membrane can be produced by mixing the proton conducting inorganic material having a layered structure and a solution containing the proton conducting polymer, subsequently mixing the resulting mixture more thoroughly in a homogenizer for 30 minutes or more, and then allowing the proton conductive inorganic material having a layered structure and the proton conducting polymer to react at 60 to 150° C.

After completion of the reaction between the proton conducting inorganic material having a layered structure and the proton conducting polymer, the reaction mixture is placed in a mold for a polymer membrane and kept in an oven that is maintained at a temperature ranging from 40 to 150° C. to obtain the polymer nano-composite membrane.

Non-limiting examples of the proton conducting polymer include perfluorated sulfonic acid polymers, sulfonated polyimides, sulfonated polyether ketones, sulfonated polystyrenes, sulfonated polysulfones, and combinations thereof. The ion exchange capacity of the proton conducting polymer is in the range of 0.01 mmol/g to 5 mmol/g.

The amount of the proton conducting polymer may be 500 to 4000 parts by weight based on 100 parts by weight of the proton conducting inorganic material having a layered structure. When the amount of the proton conducting polymer is less than 500 parts by weight, film formation may not be achieved satisfactorily. When the amount of the proton conducting polymer exceeds 4000 parts by weight, the ability of the polymer membrane to reduce methanol cross-over is deteriorated.

The polymer nano-composite membrane produced as described above has a thickness of 30 to 200 μm, which is suitable for the adoption in fuel cells.

The polymer nano-composite membrane can be used as a proton conducting membrane of the fuel cell illustrated in FIG. 1A.

In order to obtain the most efficient performance by applying the polymer nano-composite membrane to the fuel cells, the polymer nano-composite membrane can be subjected to a pretreatment. This pretreatment process helps the polymer nano-composite membrane sufficiently absorb moisture and smoothly undergo activation, and includes boiling the polymer nano-composite membrane in deionized water for about 2 hours, or boiling the polymer nano-composite membrane in a dilute sulfuric acid solution for about 2 hours and then boiling the polymer nano-composite membrane again in deionized water.

The process of producing a membrane and electrode assembly for a fuel cell using the polymer nano-composite membrane thus pretreated is as follows. The term “membrane and electrode assembly (MEA)” as used herein refers to a structure in which electrodes including catalyst layers are sequentially laminated on either side of the proton conducting polymer membrane.

The MEA according to an embodiment of the present invention can be formed by placing electrodes which include catalyst layers on both sides of the proton conducting polymer membrane and then bonding the electrodes to the proton conducting polymer membrane at high temperature and pressure, or by coating the proton conducting polymer membrane with a catalytic metal which undergoes an electrochemical catalytic reaction and then bonding fuel diffusion layers thereon.

The heating temperature and pressure for the process of bonding in the MEA formation are such that the proton conducting polymer membrane is heated to a softening temperature (about 125° C. for NAFION), and then a pressure of 0.1 to 3 ton/cm², particularly about 1 ton/cm², is applied to the proton conducting polymer membrane. The material composing the electrodes can be conductive carbon cloth or carbon paper.

Subsequently, bipolar plates are provided on both sides of the membrane and electrode assembly to complete the fuel cell. The bipolar plates used herein have grooves for supplying fuel and function as current collectors.

During the preparation of the membrane and electrode assembly, platinum only, or an alloy of platinum and at least one metal selected from gold, palladium, rhodium, iridium, ruthenium, tin and molybdenum is used as the catalyst.

Hereinafter, an aspect of the present invention will be described in more detail with reference to the following Examples. The following Examples are for illustrative purposes only, and are not intended to limit the scope of the present invention.

### EXAMPLE 1

### Addition of 1,3-PS

First, a process of imparting proton conductivity in montmorillonite, an inorganic material having a nano-sized interlayer distance, was carried out as follows.

20 g of montmorillonite was added to 500 mL of a 1N sulfuric acid solution to undergo a reaction at 60° C. for 4 hours. After the reaction, the reaction product was sufficiently washed with water to obtain pretreated montmorillonite.

1300 mmol of toluene was placed in a 500-mL round bottom flask, and the flask was purged with nitrogen (N₂). Subsequently, 60 mmol (6.12 g) of the pretreated montmorillonite was added to the flask while stirring to obtain a pretreated montmorillonite reaction mixture.

Then, 30 mmol (3.66 g) of 1,3-propane sultone was added to the pretreated montmorillonite reaction mixture. The result was mixed at 110° C. for 24 hours, then cooled, filtered, washed with toluene, and dried at ambient temperature to produce a proton conducting inorganic material with a layered structure.

### EXAMPLE 2

### Addition of 1,4-BS

A proton conducting inorganic material with a layered structure was produced in the same manner as in Example 1, except that 30 mmol (4.08 g) of 1,4-butane sultone was added to the pretreated montmorillonite reaction mixture instead of 30 mmol of 1,3-propane sultone.

### EXAMPLE 3

### Addition of Fluorinated Sultone

32 mL of toluene was added to a 100-mL round bottom flask, and the flask was purged with nitrogen (N₂). Subsequently, 20 mmol (2.04 g) of pretreated montmorillonite obtained in the same manner as in Example 1 was added to the flask while stirring to obtain a pretreated montmorillonite reaction mixture.

Then, 30 mmol (2.42 g) of a (1,2,2-trifluoro-2-hydroxy-1-trifluoromethylene)ethanesulfonic acid sultone compound was added to the pretreated montmorillonite reaction mixture. The result was mixed at 110° C. for 24 hours, then cooled, filtered, washed with toluene, and dried at ambient temperature to produce a proton conducting inorganic material with a layered structure.

### EXAMPLE 4 (PS)

0.050 g of the proton conducting inorganic material with a layered structure obtained in Example 1 was mixed thoroughly with 18.08 g of a 5 wt % solution of perfluorinated sulfonic acid as the proton conducting polymer. The mixture was heated to 90° C. and then vigorously stirred at 900 rpm. Subsequently, the reaction mixture was stirred for 3 days, transferred to a mold for producing a polymer membrane, and then heat-treated in an oven maintained at 130° C. for 4 hours to produce a polymer nano-composite membrane.

### EXAMPLE 5 (BS)

0.050 g of the proton conducting inorganic material with a layered structure obtained in Example 2 was mixed thoroughly with 18.08 g of a 20 wt % solution of perfluorinated sulfonic acid as the proton conducting polymer. The mixture was placed in an autoclave, and a reaction was allowed to occur at 90° C. and 80 psi for 24 hours.

After completion of the reaction, the reaction product was transferred to a mold for producing a polymer membrane, and then he at-treated in an oven maintained at 130° C. for 4 hours to produce a polymer nano-composite membrane.

### EXAMPLE 6 (FS)

0.050 g of the proton conducting inorganic material with a layered structure obtained in Example 3 was mixed thoroughly with 0.05 g of a 5 wt % solution of a proton conducting polymer in perfluorinated sulfonic acid. The mixture was stirred in a homogenizer at a rate of 10,000 rpm for 30 minutes, and then a reaction was allowed to occur at 90° C. and 900 rpm for 12 hours.

After completion of the reaction, the reaction product was transferred to a mold for producing a polymer membrane, and then heat-treated in an oven maintained at 130° C. for 4 hours to produce a polymer nano-composite membrane.

### EXAMPLE 7

An MEA was produced using the polymer nano-composite membrane obtained in Example 6, and then the produced MEA was used to produce a direct methanol fuel cell which uses a 2M methanol solution and air as a fuel.

### COMPARATIVE EXAMPLE 1

1 g of a 5 wt % solution of commercially available NAFION 115 membrane (DuPont, Inc.) and 0.05 g of montmorillonite were stirred in a homogenizer at a rate of 10,000 rpm for 30 minutes, and a reaction was allowed to occur at 90° C. and 900 rpm for 12 hours.

After completion of the reaction, the reaction product was transferred to a mold for producing a polymer membrane, and then heat-treated in an oven maintained at 130° C. for 4 hours to produce a polymer nano-composite membrane.

A polymeric MEA was produced using the polymer nano-composite membrane thus obtained, and then the produced MEA was used to produce a direct methanol fuel cell which uses a 2M methanol solution and air as a fuel.

The membrane and electrode assemblies produced in the Examples and Comparative Example 1 were applied to fuel cells, and the characteristics were evaluated as follows.

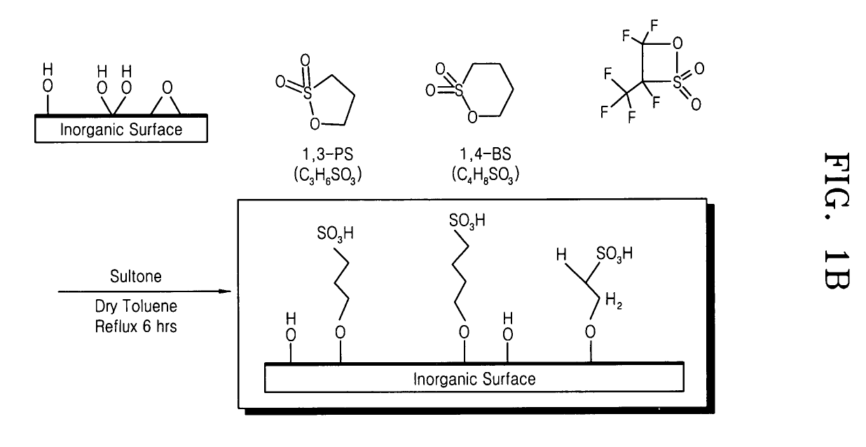

The results of X-ray photoelectron spectroscopy (XPS) carried out to confirm the presence of an SO₃H functional group in the sulfonated proton conducting inorganic material with a layered structure produced in Examples 1 through 3 are presented in FIG. 2 and Table 1 below.

TABLE 1

| | Si | S |
|---|---|---|
| 1,3-Propane sultone | 92.8 | 7.2 |
| 1,4-Butane sultone | 95 | 5 |
| Fluorinated sultone | 87.6 | 12.4 |

It can be seen from FIG. 2 and Table 1 that the proton conducting inorganic material with a layered structure which had been reacted with the fluorinated sultone compound obtained in Example 3 was substituted with more SO₃H.

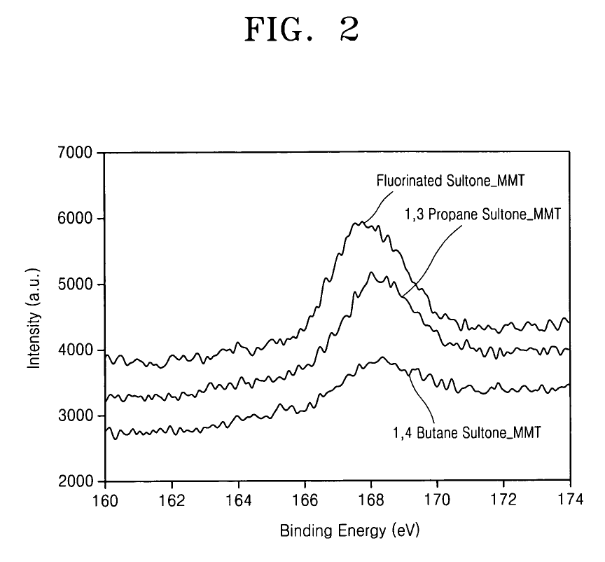

The results of thermal gravimetric analysis (TGA), which was carried out to confirm the thermal properties of the sulfonated proton conducting inorganic material produced in Example 3 and of the montmorillonite of Comparative Example 1, are presented in FIG. 3.

In the case of modified montmorillonite, which utilizes a precursor having a thiol group, it was confirmed that the functional group bound on the surface of the proton conducting inorganic material underwent decomposition at a temperature of 130° C. or higher. However, in the case of a precursor utilizing a sultone compound, it was confirmed through the TGA measurement that the modified montmorillonite having the functional group was stable up to a temperature of 180° C. or higher. This property of remaining stable at high temperatures allows the production of the polymer membrane to be carried out at high temperatures.

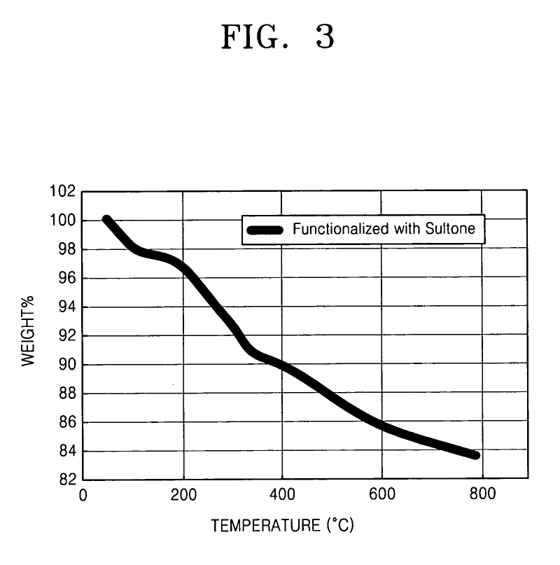

The permeability to water and methanol of the polymer nano-composite membranes of Examples 4 through 6 and of the polymer membrane of Comparative Example 1 were measured, and are presented in FIG. 4.

It can be seen from FIG. 4 that the polymer nano-composite membranes of Examples 4 through 6 had lower permeability to water and methanol than the polymer membrane of Comparative Example 1.

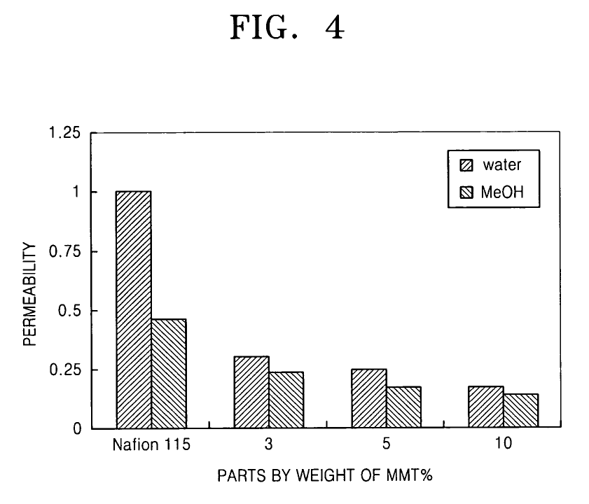

The ion conductivities of the polymer nano-composite membranes produced in Examples 4 through 6 were measured using a four-point probe method (at temperature: 50° C., relative humidity: 98%), and the results are presented in FIG. 5.

It can be confirmed from FIG. 5 that the polymer nano-composite membranes of Examples 4 through 6 had ion conductivities of 0.05 S/cm or greater. Accordingly, the polymer nano-composite membranes of Examples 4 through 6 are sufficiently applicable to fuel cells.

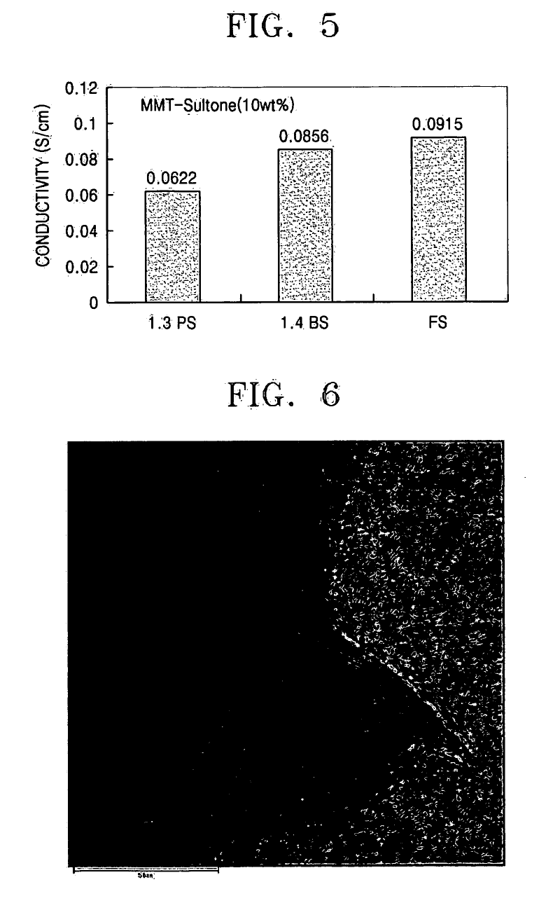

The distribution state of the polymer nano-composite membrane used in Example 6 was examined using a transmission electron microscope (TEM), and the micrograph thus obtained is presented in FIG. 6.

Referring to FIG. 6, the intercalation and exfoliation of the inorganic material montmorillonite can be observed through the morphology of the polymer nano-composite membrane.

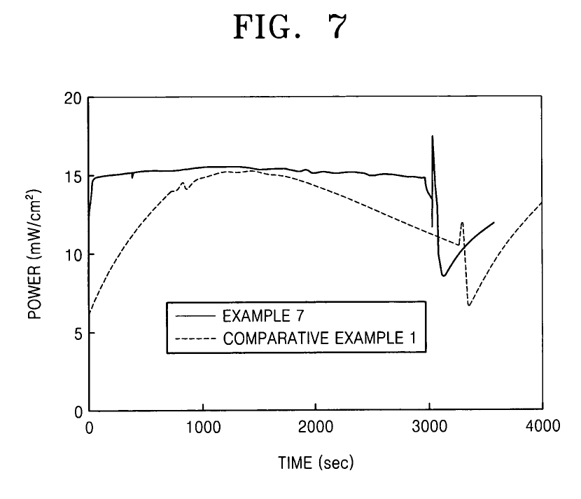

The energy densities of the methanol fuel cells produced using the membrane and electrode assembly of Example 7 and the NAFION 115 membrane of Comparative Example 1 were measured, and the results are presented in FIG. 7.

It can be seen from FIG. 7 that the fuel cell of Example 7 had greater energy density than the fuel cell of Comparative Example 1. The energy density is the power density multiplied by time, and is obtained by taking the integral of the curve of FIG. 7. Thus, it can be seen that the fuel cell of Example 7 had better performance than the fuel cell of Comparative Example 1.

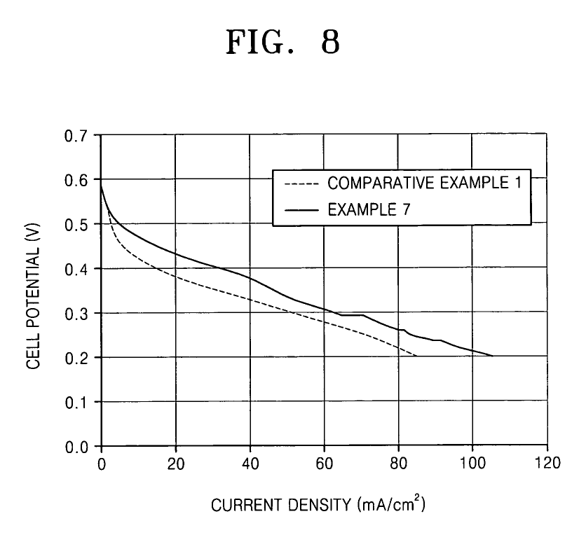

The performances of the MEAs produced in Example 7 and Comparative Example 1 were investigated, and the results are presented in FIG. 8. The MEA including the polymer nano-composite membrane produced in Example 7 had less methanol crossover and higher conductivity than the MEA of Comparative Example 1, thus having superior MEA performance.

The polymer nano-composite membrane according to an aspect of the present invention has a structure in which a proton conducting polymer is intercalated between the layers of a proton conducting inorganic material having a layered structure, or a structure in which the product obtained by exfoliating a proton conducting inorganic material having a layered structure is dispersed in a proton conducting polymer. The polymer nano-composite membrane is capable of controlling the degree of swelling caused by a methanol solution and capable of reducing the permeability according to the control of the swelling. The proton conducting inorganic material having a layered structure is imparted with a sulfonic acid group having proton conductivity, and thus the proton conductivity of the polymer nano-composite membrane can be increased. When the polymer nano-composite membrane is used as the proton conducting membrane of a fuel cell, improvements in the thermal stability, energy density and fuel efficiency of the fuel cell can be expected.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A proton conducting inorganic material having a layered structure comprising:
an inorganic material having a nano-sized interlayer distance; and
a sulfonic acid group-containing moiety having proton conductivity between the layers of the inorganic material having the nano-sized interlayer distance, wherein the sulfonic acid group-containing moiety is directly bound to the inorganic material having a nano-sized interlayer distance via an ether (—O—) bond.

2. The proton conducting inorganic material having a layered structure of claim 1, wherein the sulfonic acid group-containing moiety is
—O-AR₁SO₃H
wherein R₁ is a substituted or unsubstituted C1-C12 alkylene group or a substituted or unsubstituted C1-C12 alkenylene group, A is —C(R′)(R″)— or —C═O—, and R′ and R″ are each independently hydrogen or a C1-C10 alkyl group, or R′ and R″ together form a ring represented by the following formula: 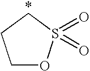
wherein * represents the position where R′ and R″ are attached to carbon; or
—O—C(R₂)(X)C(Y₁)(Y₂)SO₃H
wherein R₂ is —F, —Cl, —SF₅, ═SF₄, —SF₄Cl, —CF₃, —CF₂CF₃, —H(CF₂)₄, a C1-C12 alkyl group, a C1-C12 halogenated alkyl group, a C1-C12 alkenyl group, a C1-C12 halogenated alkenyl group, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula: 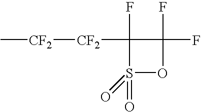
wherein X is —F, —H, —Cl or —CF₃, and Y₁ and Y₂ are each independently F or Cl.

3. The proton conducting inorganic material having the layered structure of claim 1, wherein the sulfonic acid group-containing moiety is:
—O(CH₂)ₙSO₃H wherein n is an integer from 1 to 13; or
—O—C(R₂)(X)CF₂SO₃H wherein R₂ is —F, —CF₃, —SF₅, ═SF₄, —SF₄Cl, —CF₂CF₃, or —H(CF₂)₄; and X is —F, —H, —Cl, or —CF₃.

4. The proton conducting inorganic material having the layered structure of claim 1, wherein the inorganic material having a nano-sized interlayer distance is selected from the group consisting of montmorillonite, hydrated sodium calcium aluminium magnesium silicate hydroxide, pyrophyllite, talc, vermiculite, sauconite, saponite, nontronite, amesite, baileychlore, chamosite, clinochlore, kaemmererite, kookeite, corundophilite, daphnite, delessite, gonyerite, nimite, odinite, orthochamosite, penninite, pannantite, rhipidolite, prochlore, sudoite, thuringite, kaolinite, dickite and nacrite.

5. The proton conducting inorganic material having the layered structure of claim 1, wherein the inorganic material having the nano-sized interlayer distance has an interlayer distance of 0.1 to 10 nm.

6. A method of producing a proton conducting inorganic material having a layered structure, the method comprising sulfonating the inorganic material having the nano-sized interlayer distance by adding a sultone compound to a surface of the inorganic material having the nano-sized interlayer distance to produce the proton conducting inorganic material of claim 1.

7. The method of producing the proton conducting inorganic material having the layered structure of claim 6, further comprising, before the sulfonating, hydrophilically treating the surface of the inorganic material having a nano-sized interlayer distance with an acid solution.

8. The method of producing the proton conducting inorganic material having the layered structure of claim 7, wherein the hydrophilic treatment is carried out at a temperature of 50 to 80° C.

9. The method of producing a proton conducting inorganic material having the layered structure of claim 6, wherein the sultone compound is a compound represented by the following Formula 1 or a compound represented by the following Formula 2: 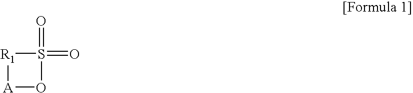
wherein R₁ is a substituted or unsubstituted C1-C12 alkylene group, or a substituted or unsubstituted C1-C12 alkenylene group, A is —C═O— or —C(R′)(R″)—, and R′ and R″ are each independently hydrogen or a C1-C10 alkyl group, or R′ and R″ together form a ring represented by the following formula: 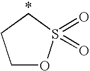
wherein * indicates the position where R′ and R″ are attached to carbon; 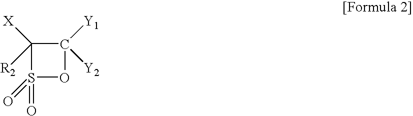
wherein R₂ is —F, —Cl, —SF₅, ═SF₄, —SF₄Cl, —CF₃, —CF₂CF₃, —H(CF₂)₄, C1-C12 alkyl, C1-C12 halogenated alkyl, C1-C12 alkenyl, C1-C12 halogenated alkenyl, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula: 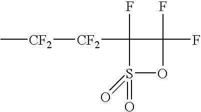
wherein X is —F, —H, —Cl or —CF₃, and Y₁ and Y₂ are each independently F or Cl.

10. The method of producing the proton conducting inorganic material having the layered structure of claim 9, wherein the compound represented by formula 1 is selected from the group consisting of 1,3-propane sultone (A), 1,4-butane sultone (B), and Compound (C) through Compound (S), which are represented by the following formulas:

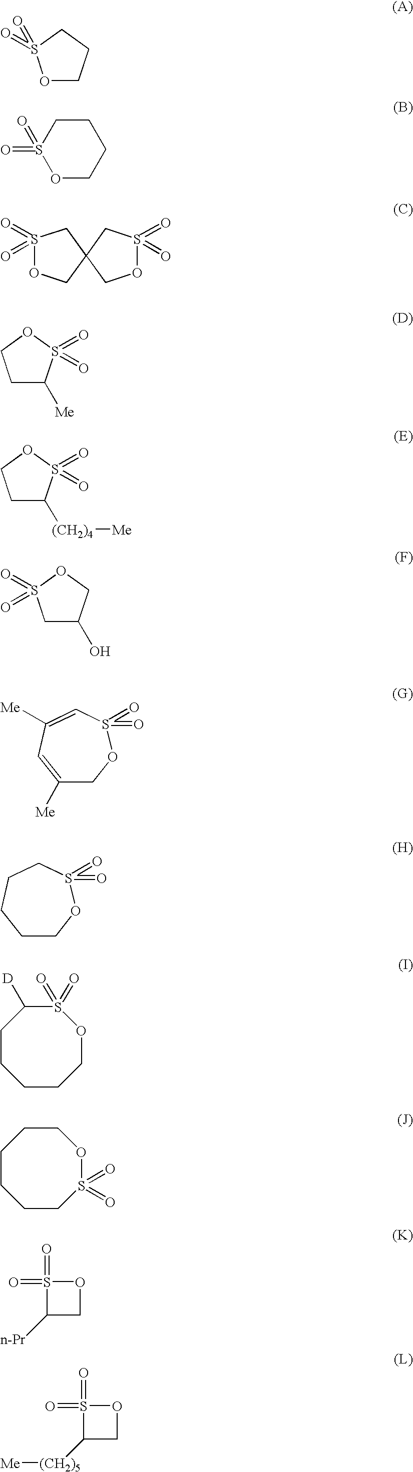

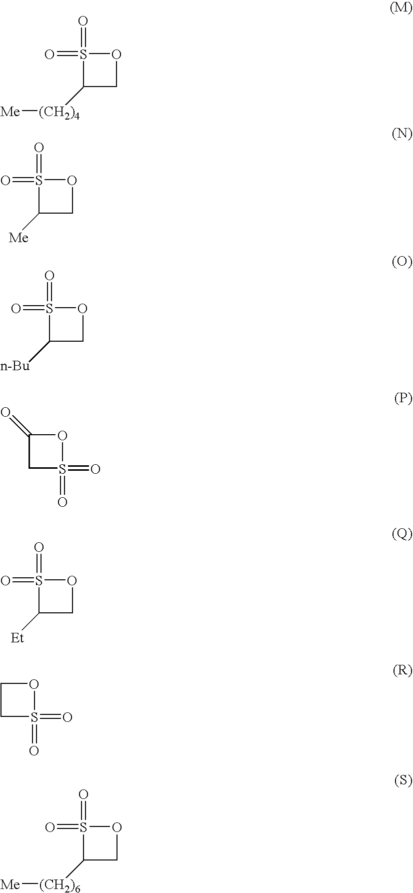

11. The method of producing the proton conducting inorganic material having the layered structure of claim 9, wherein the compound represented by Formula 2 is selected from the group consisting of Compound (A′) through Compound (Z′) and Compound (a′) and Compound (b′):

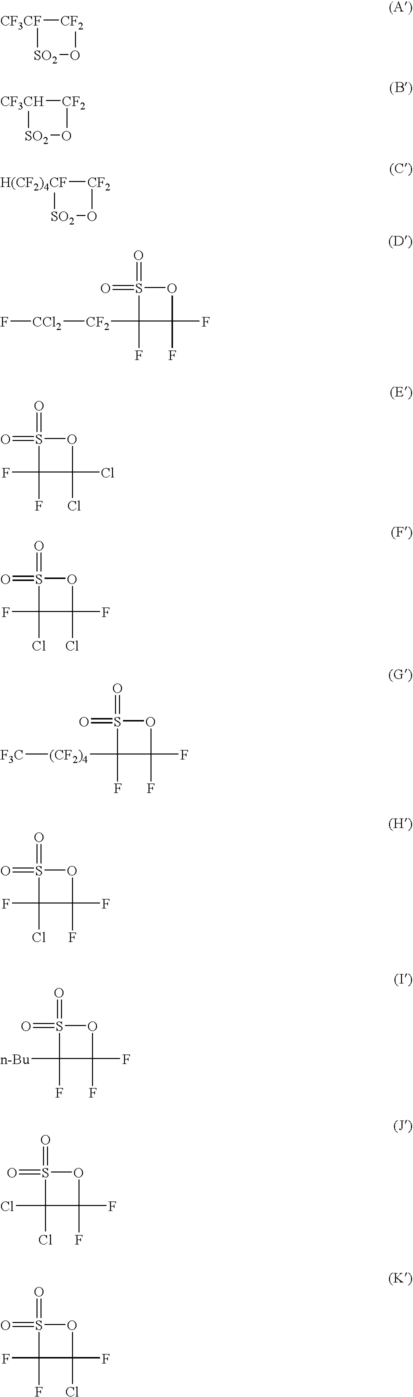

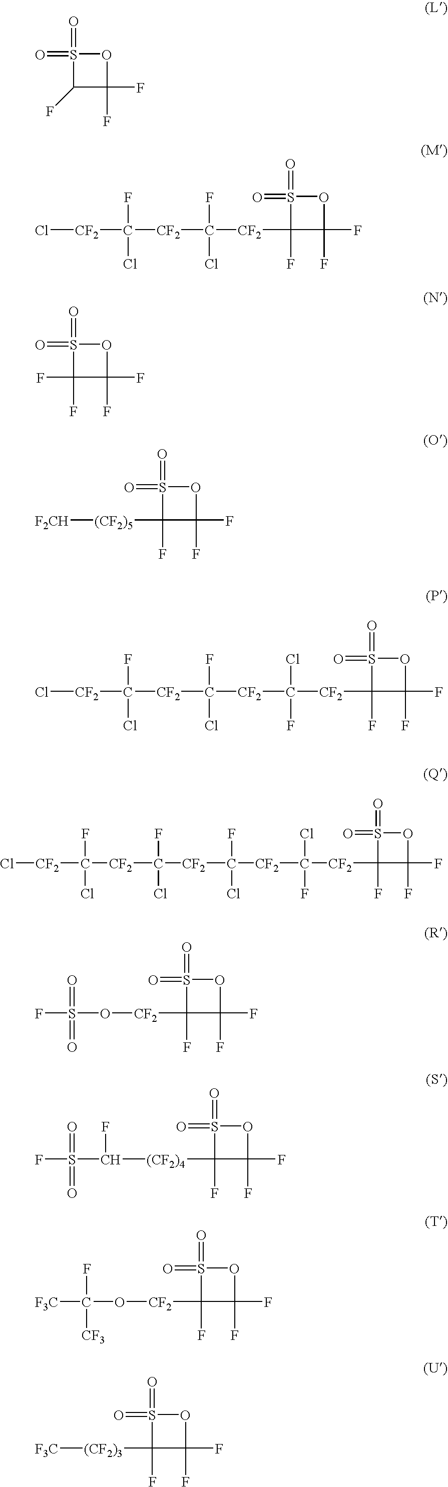

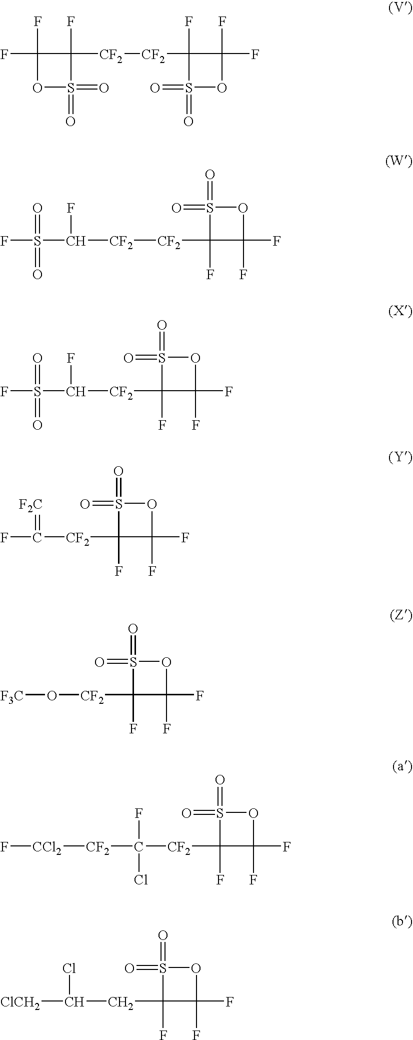

12. The method of producing the proton conducting inorganic material having a layered structure of claim 6, wherein the sultone compound is selected from the group consisting of 1,3-propane sultone, 1,4-butane sultone, and (1,2,2-trifluoro-2-hydroxy-1-trifluoromethylene)ethanesulfonic acid sultone.

13. The method of producing the proton conducting inorganic material having a layered structure of claim 6, wherein 0.1 to 2 moles of the sultone compound is reacted with 1 mole of the inorganic material having the nano-sized interlayer distance.

14. The method of producing the proton conducting inorganic material having the layered structure of claim 7, further comprising adding surfactants to the inorganic material having the nano-sized interlayer distance before the hydrophilically treating.

15. The method of producing the proton conducting inorganic material having the layered structure of claim 14, wherein the surfactant is at least one surfactant selected from the group consisting of dodecylamine, cetyltrimethylammonium bromide, dodecyltrimethylammonium bromide and tetrabutylammonium hydroxide.

16. A polymer nano-composite membrane comprising
a proton conducting polymer; and
a proton conducting inorganic material having a layered structure comprising:
an inorganic material having a nano-sized interlayer distance; and
a sulfonic acid group-containing moiety having proton conductivity introduced between the layers of the inorganic material having a nano-sized interlayer distance, wherein the sulfonic acid group-containing moiety is directly bound to the inorganic material having a nano-sized interlayer distance via an ether (—O—) bond.

17. The polymer nano-composite membrane of claim 16, wherein the sulfonic acid group-containing moiety is
—O—AR₁SO₃H
wherein R₁ is a substituted or unsubstituted C1-C12 alkylene group or a substituted or unsubstituted C1-C12 alkenylene group, A is —C(R′)(R″) or —C═O—, and R′ and R″ are each independently hydrogen or a C1-C10 alkyl group, or R′ and R″ together form a ring represented by the following formula: 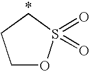
wherein * represents the position where R′ and R″ are attached to carbon; or
—O—C(R₂)(X)C(Y₁)(Y₂)SO₃H
wherein R₂ is —F, —Cl, —SF₅, ═SF₄, —SF₄Cl, —CF₃, —CF₂CF₃, —H(CF₂)₄, a C1-C12 alkyl group, a C1-C12 halogenated alkyl group, a C1-C12 alkenyl group, a C1-C12 halogenated alkenyl group, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula: 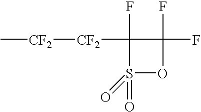
wherein X is —F, —H, —Cl or —CF₃, and Y₁ and Y₂ are each independently F or Cl.

18. The polymer nano-composite membrane of claim 16, wherein the sulfonic acid group-containing moiety is:
—O(CH₂)ₙSO₃H wherein n is an integer from 1 to 13; or
—O—C(R₂)(X)CF₂SO₃H wherein R₂ is —F, —CF₃, —SF₅, ═SF₄, —SF₄Cl, —CF₂CF₃, or —H(CF₂)₄; and X is —F, —H, —Cl, or —CF₃).

19. The polymer nano-composite membrane of claim 16, wherein the proton conducting polymer is intercalated between the layers of the proton conducting inorganic material having a layered structure, a product obtained by exfoliating the respective layers constituting the proton conducting inorganic material having a layered structure is dispersed in the proton conducting polymer, or the polymer nano-composite membrane has a combined structure of the proton conducting polymer intercalated between the layers of the proton conducting inorganic material having a layered structure and a product obtained by exfoliating the respective layers constituting the proton conducting inorganic material having a layered structure dispersed in the proton conducting polymer.

20. The polymer nano-composite membrane of claim 16, wherein the proton conducting polymer includes at least one polymer selected from the group consisting of perfluorated sulfonic acid polymers, sulfonated polyimides, sulfonated polyether ketones, sulfonated polystyrenes, and sulfonated polysulfones.

21. The polymer nano-composite membrane of claim 16, wherein the proton conducting polymer is contained in an amount of 500 to 4000 parts by weight based on 100 parts by weight of the proton conducting inorganic material having a layered structure.

22. A fuel cell comprising the polymer nano-composite membrane comprising:
a proton conducting polymer; and
a proton conducting inorganic material having a layered structure comprising:
an inorganic material having a nano-sized interlayer distance; and
a sulfonic acid group-containing moiety having proton conductivity introduced between the layers of the inorganic material having a nano-sized interlayer distance, wherein the sulfonic acid group-containing moiety is directly bound to the inorganic material having a nano-sized interlayer disctance via an ether (—O—) bond.

23. The fuel cell of claim 22, wherein the sulfonic acid group-containing moiety is
—O—AR₁SO₃H
wherein R₁ is a substituted or unsubstituted C1-C12 alkylene group or a substituted or unsubstituted C1-C12 alkenylene group, A is —C(R′)(R″)— or —C═O—, and R′ and R″ are each independently hydrogen or a C1-C10 alkyl group, or R′ and R″ together form a ring represented by the following formula: 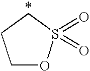
wherein * represents the position where R′ and R″ are attached to carbon; or
—O—C(R₂)(X)C(Y₁)(Y₂)SO₃H
wherein R₂ is —F, —Cl, —SF₅, ═SF₄, —SF₄Cl, —CF₃, —CF₂CF₃, —H(CF₂)₄, a C1-C12 alkyl group, a C1-C12 halogenated alkyl group, a C1-C12 alkenyl group, a C1-C12 halogenated alkenyl group, —CF₂OSO₂F, —(CF₂)₄CHFSO₂F, —CF₂CF₂CHFSO₂F, —CF₂CHFSO₂F, —CF₂OCF(CF₃)CF₃, —CF₂C(═CF₂)F, —CF₂OCF₃, —CF₂C(F)(Cl)CF₂CCl₂F, —CH₂CH(Cl)CH₂Cl, or a group represented by the following formula: 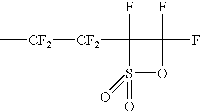
wherein X is —F, —H, —Cl or —CF₃, and Y₁ and Y₂ are each independently F or Cl.

24. The fuel cell of claim 22, wherein the sulfonic acid group-containing moiety is:
—O(CH₂)ₙSO₃H wherein n is an integer from 1 to 13; or
—O—C(R₂)(X)CF₂SO₃H wherein R₂ is —F, —CF₃, —SF₅, ═SF₄, —SF₄Cl, —CF₂CF₃, or —H(CF₂)₄; and X is —F, —H, —Cl, or —CF₃.

25. The fuel cell polymer of claim 22, wherein the proton conducting polymer is intercalated between the layers of the proton conducting inorganic material having a layered structure, a product obtained by exfoliating the respective layers constituting the proton conducting inorganic material having a layered structure is dispersed in the proton conducting polymer, or the polymer nano-composite membrane has a combined structure of the proton conducting polymer intercalated between the layers of the proton conducting inorganic material having a layered structure and a product obtained by exfoliating the respective layers constituting the proton conducting inorganic material having a layered structure dispersed in the proton conducting polymer.
